(19) United States
(12) Patent Application Publication
(10) Pub. No.: US 2003/0144862 A1
(43) Pub. Date: Jul. 31, 2003

(54) Automated employment fulfillment system

(76) Inventors: Peggy Smith, Thousand Oaks, CA (US); Linda Frazeur, Simi Valley, CA (US)

Correspondence Address: KOPPEL JACOBS PATRICK & HEYBL, Suite 107, 555 St. Charles Drive, Thousand Oaks, CA, 91360, US

(21) Appl. No.: 10/132,794

(22) Filed: Apr. 24, 2002

Related U.S. Application Data
(60) Provisional application No. 60/285,955, filed on Apr. 24, 2001.

(51) Int. Cl. G06F 17/60

(52) U.S. Cl. 705/1

(57) ABSTRACT

A method and computer implemented system of matching per diem employees with job openings from employers is disclosed. A Web site system is provided that includes a browsable employee database of employee data entries, each of the employee data entries pertaining to an employee. Each of the employee data entries contains employee profile information and an indicator, which indicates whether the employee the entry pertains to is available for employment. A data entry activation system then allows each of the employees to change the indicator in their respective data entry, the change capable of occurring in real time without interrupting the operation of said Web site system. An employee database search system an employer to search the database based on selected search parameters. The search system only considers the data entries wherein the indicator indicates that the employee is available for employment. The method then determines which data entries match the search parameters and then reports the matching date entries to the employer. The data entry activation system can be a telephone interface server, which allows the employees to remotely change their availability indicator.

This application claims the benefit of provisional application No. 60/285,955 to Smith, et al., which was filed on Apr. 24, 2001.

### BACKGROUND OF THE INVENTION

1. Field of the Invention

This invention relates to systems for matching employees with prospective jobs and, more specifically, to a dynamic employee profile-driven Internet based system for matching employees with jobs.

2. Description of the Related Art

Many per diem service-related industries find it difficult to quickly and easily match a job opportunity with a qualified professional. For instance, in the court reporting industry last-minute job opportunities regularly arise, such as transcription of deposition or court proceedings. The job opportunities are usually given to a court reporter agency that maintains a privately held list of qualified professionals suitable to perform services for their clientele. The agency must then locate a qualified and available court reporter and secure a commitment to perform. This often requires the agency personnel to make numerous calls to various court reporters to determine if they are available, which can require many phone calls and can take several hours. In some instances, the agency is unable to locate a qualified reporter and either the job goes unfilled or is filled by a competing agency.

Also, on a daily basis court reporters must seek acceptable work to perform, which can also be laborious task. The same problems are experienced in other per diem professions, including but not limited to videographers, translators, and nurses.

Calendar management services are available to manage the calendars of court reporting agencies by maintaining a list of qualified reporters and tracking their availability using a large white board. A member agency informs the center of an available reporting job and the center contacts available reporters by phone to fill the job. These centers usually charge the agency either per month or per job and the cost can be significant. Also, this system still relies on contacting the court reporter by phone to secure their commitment to work.

Online services today offer a variety of services to their users. Users may access news, weather, financial, sports, and entertainment services, participate in and retrieve information from online discussion groups, and send and receive email. A user of an online service typically accesses the service using specialized communication software (i.e., client application or client software) that establishes and manages a connection from the user's computer to the service provider's host computers (or servers) and facilitates the user's interactions with the service.

In addition to managing the connection, there is provided software to display pages or screens relating to retrieved content according to views or presentations specific to the online service. This software may be integrated with the client application. The functionality of the content and the user interface (i.e., icons, dialog boxes, menus, etc.) for interacting with the content are typically dictated by various standards.

Communications between the user's computer and the service are facilitated by a variety of software protocols (i.e., communication conventions, rules and structures), including application level protocols, for managing the transfer of data across the network and to the client application on the user's computer. A protocol may be proprietary or exclusive to a service such that only client software from the service provider may be used to communicate with the server software. For example, an online service that supports electronic mail, discussion groups, chat groups, news services, etc., may define and use specific protocols for each type of service so that appropriate information is exchanged between the participants (i.e., clients and servers). Each application-specific protocol may be based on a common, underlying protocol.

The Internet and World Wide Web (“Web”), comprised of a vast array of international computer networks, provide online service users with considerable information resources and other content. Typically, this content is accessed using a web browser, such as Microsoft Internet Explorer or Netscape Navigator, capable of understanding the HyperText Markup Language (HTML) used to create the documents found on the Web and the HyperText Transfer Protocol (HTTP) used to navigate the Web. Email discussion groups are typically accessed through companion software to the browser. Although web browsers typically have varying levels of functionality or sophistication, retrieved content is displayed in content pages according to views or presentations specific to the web document currently presented by the web browser. Typically, the views and presentations are different than those provided by the communication software from the online service because the web browser is a separate client application displaying web documents containing presentation directives.

When using a browser, the browser issues HTTP messages to request web pages. A requested web page is typically identified using its URL—uniform resource locator. The URL is a reference (or address) to a resource available on a TCP/IP network such as the Internet. A URL is composed of a character string, and may have a number of parts. These parts include a top-level domain name, second level domain name, directory name, and file name. URLs may identify a file located on a web server. URLs may also point to other resources on the network such as database queries and command output. The determination and use of URLs is well known in the art and is not discussed further herein.

There are a number of ways that a user can connect to the Internet. First, a user can subscribe to a proprietary online network, such as, for example, America Online. Second, a user can subscribe to an Internet Service Provider (ISP). In any case, users typically connect to the Internet using a computer with a communications device such as an analog modem, an Ethernet adapter, DSL adapter or cable modem. Such connections may be analog or digital, dial-up or constantly connected. Subscribers typically pay a fee for their subscriptions to proprietary online networks and ISPs. These fees typically are in the form of a sign-up fee, plus on-line charges, which are fixed (i.e., unlimited monthly access for a fixed fee) or based upon the amount of time the user is connected. The fees generally increase with bandwidth.

An Internet-based system called CSR-Now (www.csr-now.com) assists court reporting firms in finding reporters to cover last-minute jobs or exceptionally heavy calendars. CSR-Now offers to connect court reporters and agencies using a national database and a toll free number that is manned by CSR-Now personnel. The reporter specifies the date, time, and location they can service, and a phone number at which they can be immediately reached. Further information about each individual reporter is accessible to court reporting firms. However, this system does not provide an automated system for court reporters to remotely indicate their availability for work easily and in real time. Also, this system does not allow an agency to search the subscribing court reporters for immediate and long-term jobs that are available. There is no mechanism for non-subscribing members of the public to post last minute job listings.

### SUMMARY OF THE INVENTION

The present invention provides a new employment fulfillment method and computer-implemented system that is particularly applicable to industries that operate on a per diem basis, although it can also be used for filling other types of employment. The invention provides professionals with a safe, convenient, and cost-effective environment for presenting themselves to the business communities they serve, while at the same time providing a quick and easy way for the employee to be removed from consideration when they are not available to work. It also provides a quick, easy, and cost-effective system for the particular business community (“agency”) to find and contact the available and qualified professionals to meet its current job needs.

One embodiment of a method of matching per diem employees with job openings from employers, according to the present invention, comprises providing a web site system that includes a browsable employee database. The database includes a plurality of employee data entries, with each of the employee data entries pertaining to one of the employees. Each of the employee data entries has an indicator, which indicates whether the employee is available for employment. The method then provides an employee data entry activation system which allows each of the employees to change his/her indicator, the change capable of occurring in real time without interrupting the operation of said Web site system. The method then provides an employee database search system which allows one of the employers to search the database based on selected search parameters. The search system only considers the data entries wherein the indicator indicates that the employee is available for employment. The method then determines which data entries match the search parameters and then reports the matching data entries to the employer.

A preferred method allows the employee to change his/her indicator remotely using a land or cell phone, which provides a communication link between the employee and the Web system. The method can also provide a Web site employee subscription system, which allows said employee to electronically enter said employee's profile information and availability indicator in the database. A Web site employer subscription system can also be provided which allows the employer to utilize the search system to search the database on search parameters.

One embodiment of a computer-implemented system according to the present invention electronically reports available per diem employees to employers with potential job opportunities that match the employee's location and qualifications. The system includes an electronically browseable employee database, which comprises a plurality of employee date entries. Each of the data entries includes an employee profile and an available indicator for each employee, with the employee being available for employment when the available indicator is active. The system also includes an employee subscription system which implements an electronic subscription process to at least partially automate entry of each of the employee profiles into the database. An available indicator modification system is also included, which allows each of the employees to electronically change the employee's respective available indicator in real time. The system also includes an employer subscription system which implements an electronic employer subscription process to at least partially automate employer access to the database. A search system allows each of the employers to search the database, the search system only searching on the employee profiles having an active available indicator.

These and other further features and advantages of the invention will be apparent to those skilled in the art from the following detailed description, taken together with the accompanying drawings, in which:

### BRIEF DESCRIPTION OF THE DRAWINGS

FIG. 1 is a block diagram illustrating the primary components of a Web based employment system according to the present invention;

FIG. 2 is a block diagram of the primary components and communication between components for a subscribing employee;

FIG. 3 is a contact information form displayed at the employee's computer display;

FIGS. 4a and 4b are Professional Profile forms displayed at the employee's computer display;

FIG. 5 is a flow diagram for the telephone interface server controlled process of the employee changing his/her active indicator;

FIG. 6 is a block diagram of the primary components and communication between components for the telephone interface server when changing the employee active indicator;

FIG. 7 is a block diagram of the primary components and communication between components for a subscribing employer;

FIG. 8 is an Agency Profile form displayed at the employer's computer display;

FIG. 9 is a Search for Reporters form displayed at the employer's computer display;

FIG. 10 is a block diagram of the primary components and communication between components for non-subscribing employers to list jobs; and

FIG. 11 is a Job Listing form displayed at a non-subscribing employer's computer display.

### DETAILED DESCRIPTION OF THE INVENTION

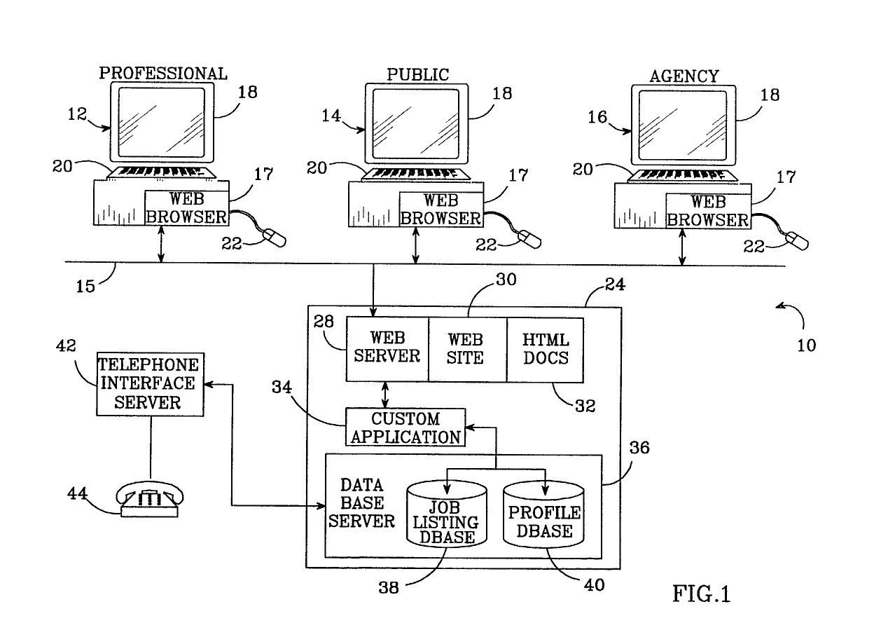

FIG. 1 shows the general architecture of an employment fulfillment system 10 in accordance with the present invention. It includes a professional computer 12, a public computer 14, an agency computer 16, all of which are capable of communicating over a communication network 15, the preferred network being the Internet (also referred to as “World Wide Web” or “Web”). The computers 12, 14, 16 may be any type of computing device that allows a user to interactively browse websites over the Internet 15 via a web browser. In the preferred system, the computers 12, 14, 16 are each a personal computer (PC) running a Microsoft Windows operating system and having a commercially available web browser 17.

Each of the computers 12, 14, 16 preferably include as an output device, and as a display 18, and input device such as a keyboard 20 and/or pointing device 22 (e.g. mouse, track ball, or data glove). Each of the computers can alternatively be an Internet appliance, network computer, or an appropriately Internet-enabled device such as a portable digital assistant (PDA), mobile phone, refrigerators, etc. The particular type of computer is not considered to be important so long as it can provide some measure of individual Internet user interactivity.

The primary software and databases for the system 10 reside in a server/site 24 and the telephone interface server 42. The server/site 24 may be of a type known in the art and has the ability to serve web pages to the computers 12, 14, 16. It should be appreciated that the server/site 24 is generic for any source of web pages to the computer 12, 14, 16. For example, the server/site 24 could be accessible from the Internet, or it could be a part of an intranet and can represent any number of servers.

The web server 28 resides on the server/site 24 and the computers 12, 14, 16 primarily communicate with the server/site 24 and its web server 28 over the Internet 15. The web server 28 also includes the web site software 30, and the web site's HTML documents 32. The server/site 24 also includes custom application software 34 to implement the functions described below, such as system subscription, database management, and communication.

The server/site 24 has a commercially available database server 36 that is programmed and communicates with the custom application software 34 to maintain the site's databases. A preferred database server 36 is a SQL server that searches its databases by structured query language. The two primary databases residing in the database server 36 include the profile database 40 and the job listing database 38. The system 10 includes a commercially available telephone interface server 42 that is programmed to be the communication link between land and/or cell phones 44 and the database server 36. This allows a subscribing professional to activate or deactivate their profile over the phone.

Professional

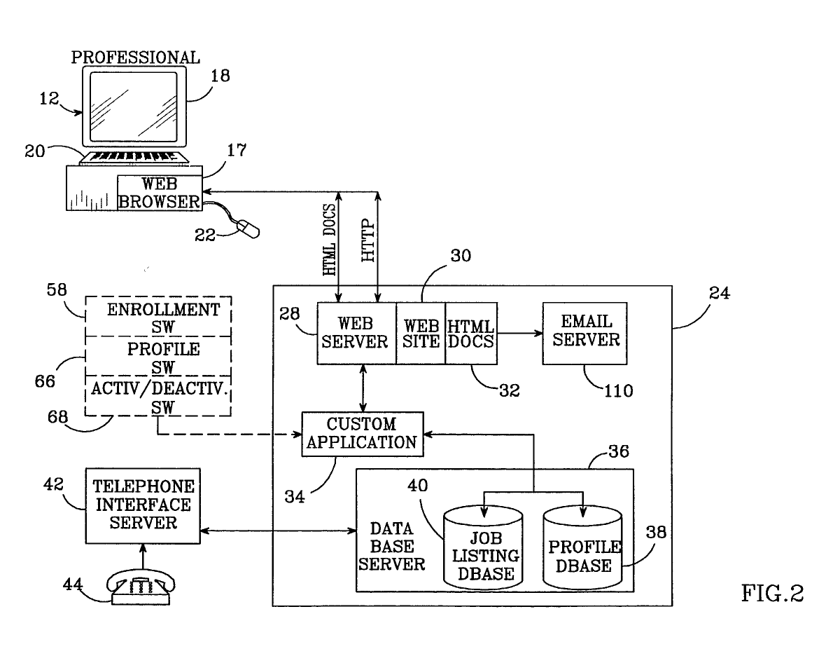

In this disclosure, the term “professional” refers to an individual offering his/her employment services on a per diem bases, and includes, but is not limited to court reporters, videographers, interpreters, proofreaders, scopists, nurses and truck drivers. FIG. 2 shows the essential components involved in information flow between a subscribing professional's computer 12 in the server/site 24.

In operation, a professional accesses the server/site 24 using a standard web browser 17 residing on the professional's computer 12 by entering the systems URL address (e.g., www.reporterpage.com). A typical Web browser is Microsoft's Internet Explorer, which uses Hyper Text Transport Protocol (HTTP) to communicate with the Web Server 28 and the web site software 30. In response to the URL, the Web Server sends the system's home page to the professional's computer 12, where it is visible on the display 18.

A professional first enrolls (subscribes) in the system 10 before he/she can access the subscriber pages and features of the system 10, including entering a profile for matching to potential jobs. At the professional's computer 12 the “Professionals” option is chosen on the system's home page. The professional then selects the appropriate subscription option for type of professional, some of the options being reporter, interpreter, videographer, scopist and proofreader.

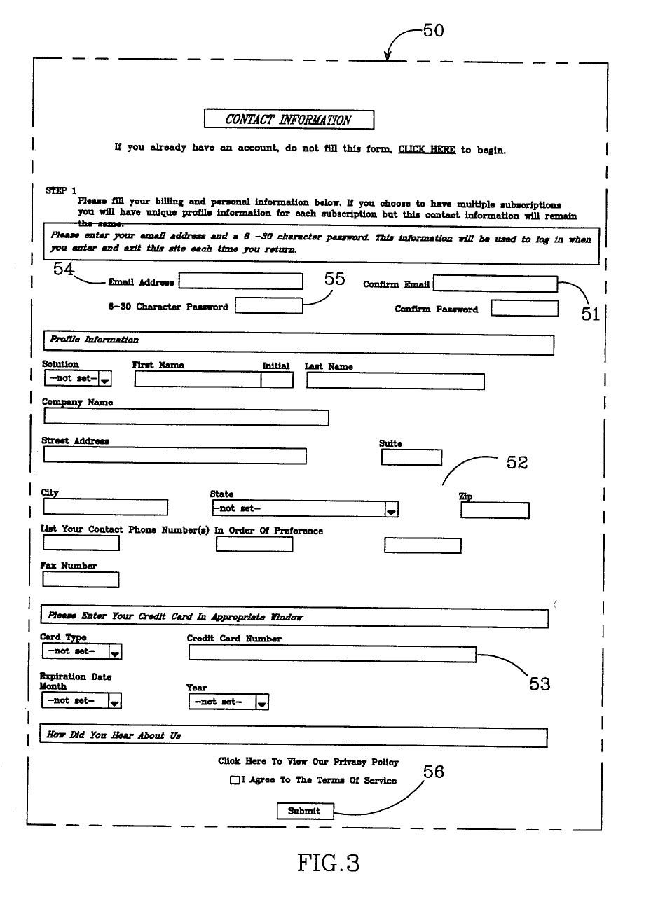

The Web server 28 then accesses its HTML enrollment documents 24, which are viewed at the professional's computer display 18, with the first page being a “Contact Information” page. FIG. 3 shows a typical “Contact Information” page 50, which requests certain information from the professional. The professional inputs the information into the blanks, preferably by typing the using the computer's keyboard input device 20. Some of the requested information includes name 51, address 52, credit card information 53, email address 54 and password 55. When done, the professional enters the enrollment information by activating the submit button 56, which results in the contact information being sent to the Web server 28. In alternative embodiments, the enrollment information can be submitted to the Web site by other methods such as email or phone.

In response to the submitted contact information, the web server 28 initiates enrollment software 58 within its custom application software 34 to process the information contained in the enrollment form 50. As part of the enrollment process, the subscriber uses his/her email address 54 for identification and chooses a password 55, both of which are used in future logins to enter the system 10 and access the subscriber pages and features.

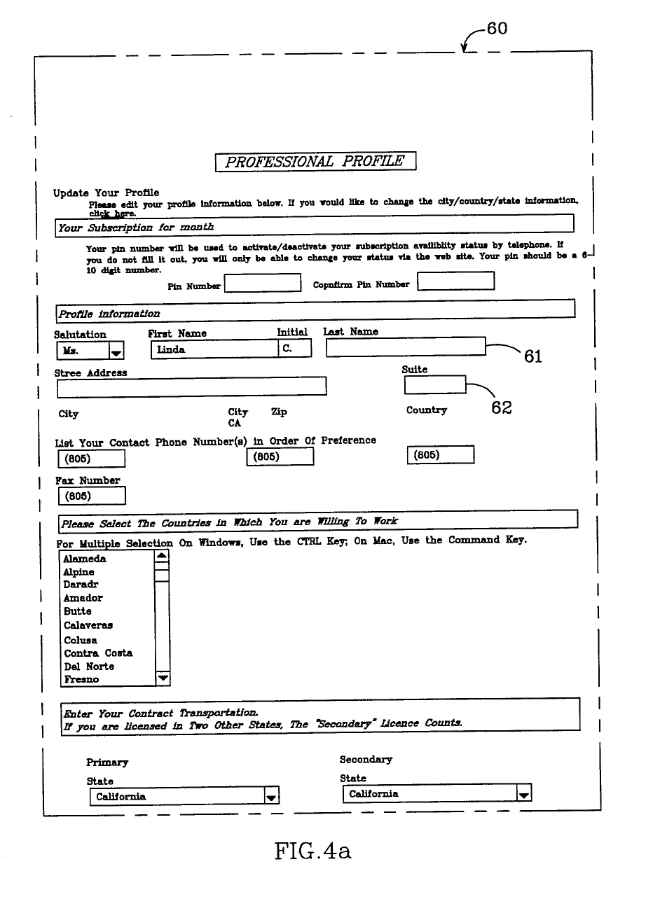

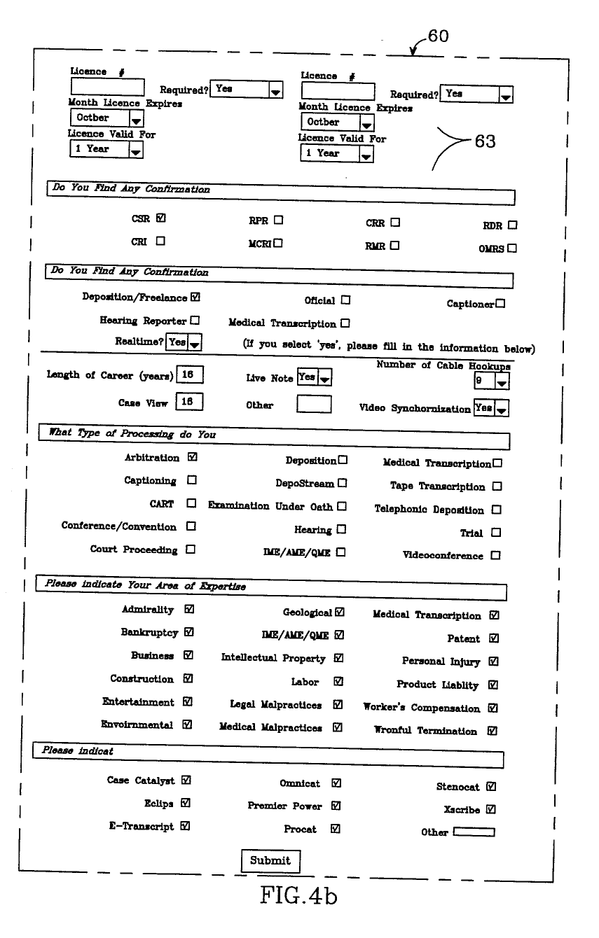

Once the enrollment process is complete, the professional selects the profile option under the professional section. The Web server 28 accesses the profile documents'store of HTML documents 32, which are then viewed at the professional's computer display 18. FIGS. 4a and 4b show typical profile pages 60 with blanks for the professional to include profile information including, but not limited to, name 61, address 62, qualifications 63, type of work willing to accept and areas of expertise 64. Once the form is completed and the submit button is activated, the information in the profile form 60 is sent to the Web server 28. In response to the profile forms, the Web server 28 initiates profile software within 66 its custom application software 34 which, among other tasks, processes the profile information and stores it in the profile database 40.

After the enrollment and profile information is submitted, the professional becomes an active member of the system 10. When the professional enters the system from the home page by entering the email address and password, the system notifies the professional whether the professional profile is activated. The professional can then activate or deactivate the profile information using the computer 12 by sending an HTTP command to activate or deactivate. This causes the Web server 28 to initiate activation/deactivation software 68 in the custom application software 34, which allows the professional to change the appropriate field in the employee's profile to reflect the employees availability for employment.

The professional can also activate and deactivate his/her profile by phone through the telephone interface server 42. In the preferred system, the telephone server 42 is a commercially available DIALOG/4 from Dialogic Corporation. The custom features of the telephone server 42 are programmed using VOS software. When the professional enters the activate/deactivate command by phone, the telephone server 42 communicates directly with the database server 36 to change the appropriate field within the professional's profile.

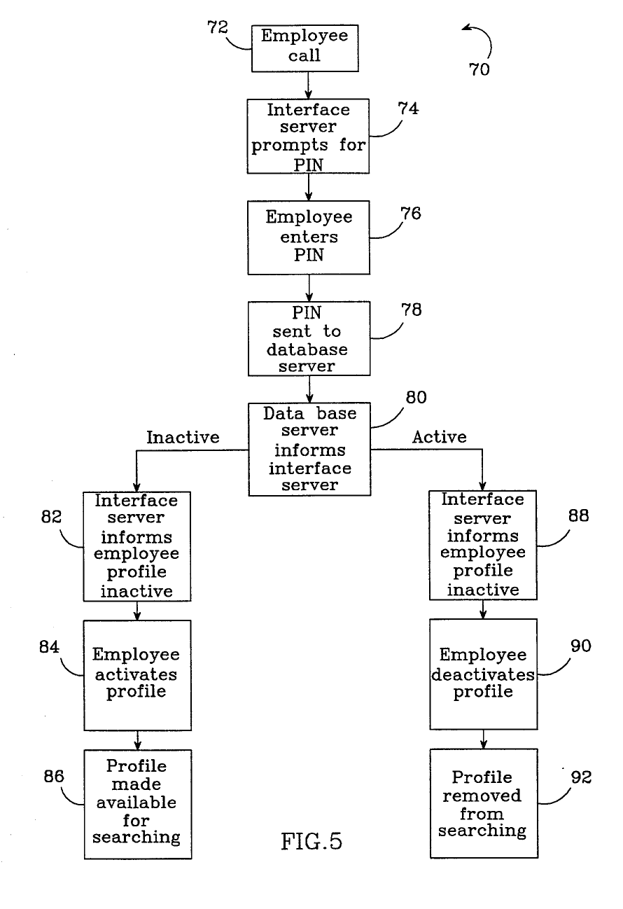

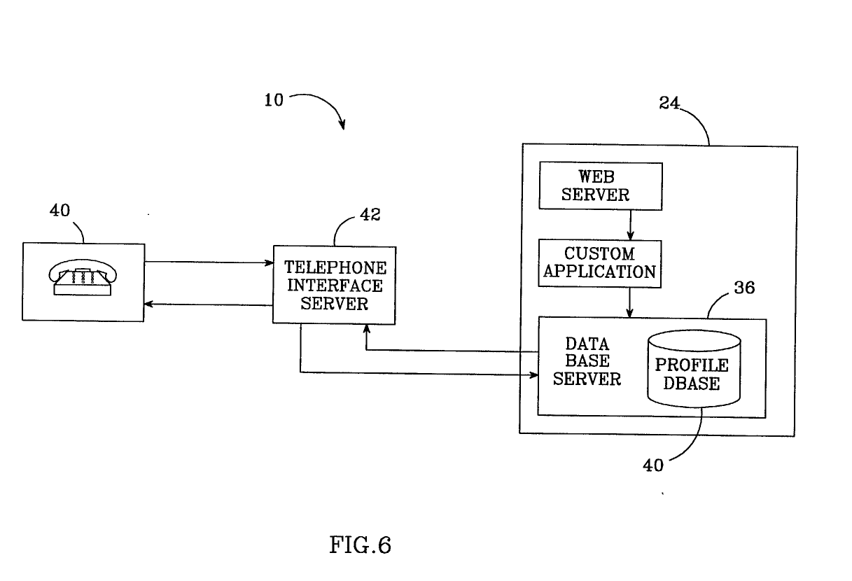

FIG. 5 shows a flow diagram 70 for a telephonic activation/deactivation of a professional profile according to the present invention and FIG. 6 shows the general flow 90 of information between components when a professional activates or deactivates a profile by phone. In step 72 the professional begins communication with the telephone interface server 42 by dialing a telephone number (preferably toll free) that connects the professional to the telephone interface server 42, also referred to as a VOS box. The telephone interface server is programmed to respond to a cell or land phone 84 that dials the server's number.

In step 74, the interface server 42 prompts the professional with verbal instructions for the professional to enter the appropriate PIN and in step 76 the PIN is entered by the professional using the telephone number pad. In step 78, software within the interface server 42 interprets the professional's keypad entries and communicates the PIN to the database server 36 to identify and retrieve the appropriate profile from the profile database 40.

In step 80 the database server 36 informs interface server 42 whether the professional's profile is active or inactive. If the profile is inactive, in step 82 the interface server informs the professional that the profile is inactive and asks the professional if he/she would like to activate the profile. In step 84, the professional activates the profile by pressing the designated number on the phone keypad, preferably “1.” This activation is communicated to the database server 36, which in step 86, makes the profile active for searching. The profile remains active until the professional deactivates it.

If the profile is active, in step 88 the interface server informs the professional that the profile is active and asks the professional if he/she would like to deactivate the profile. In step 90, the professional deactivates the profile by pressing the designated number on the phone keypad, preferably “2.” This deactivation is communicated to the database server 36, which in step 92, deactivates the profile for searching. The profile remains inactive until the professional activates it.

A subscribing professional can also search the profile database 40 for agencies within its profession to market the professional's services to the other agencies. The professional can also search the profile database 40 for other professionals outside of his/her profession to cross-market to the related professionals. The professional can also update his/her profile or subscribing information, or cancel his/her subscription.

Agency

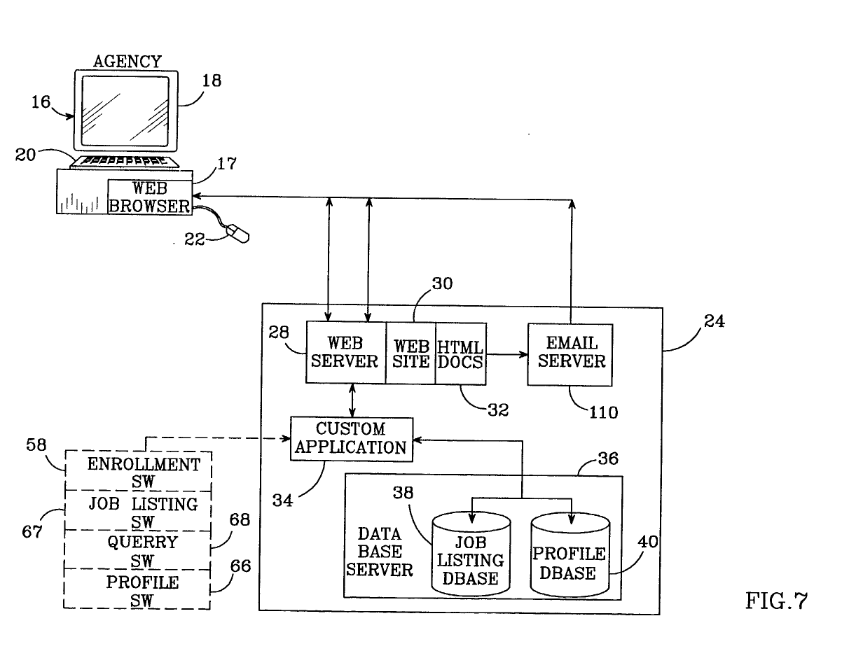

In this disclosure, the term “agency” refers to any employer offering jobs to professionals, particularly on a per diem basis, and includes, but is not limited to court reporting agencies, employment agencies, companies and individuals. FIG. 7 shows the general flow of information between a subscribing agency's computer 16 and the server/site 24. The agency computer 16 has a standard Web browser 17 and an agency subscribes to the system 10 in much the same way as a professional by accessing, completing and submitting subscription HTML forms. The agency must also provide an email address and select a password to be used for secure logins.

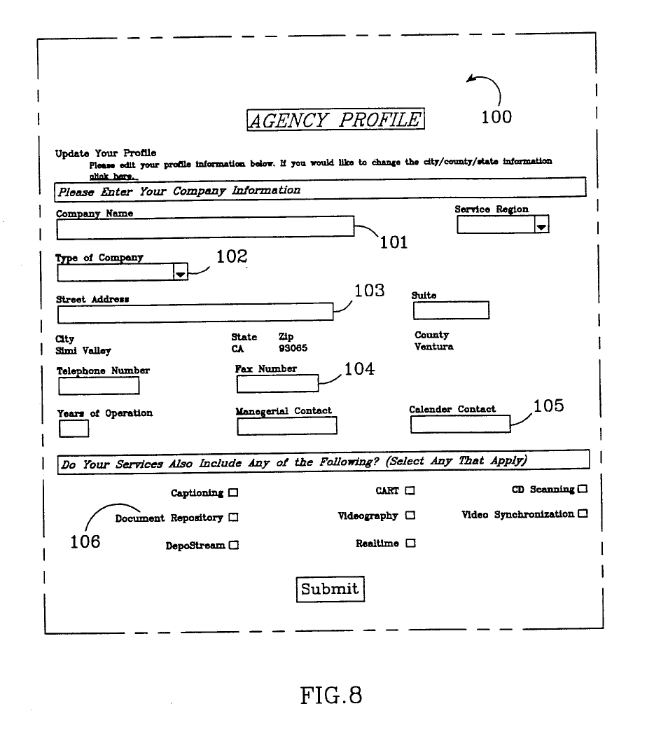

After the agency subscribes, it also completes an agency profile that is then stored in the profile database 30. FIG. 8 shows a typical agency profile form having blanks for information about the agency such as name 101, type of company 102, address 103, telephone numbers 104, contacts 105, and specialized services 106. When the form 100 is complete, the submit button is activated and the information from the form is stored in the profile database 40 under control of the profile software 66.

The agency profiles allows the system 10 to search the profiles database 40 to alert the appropriate agencies when a new job has been listed by a non-subscribing employer (as described below). Under control of the job listing software 67 in the custom application 34, the agency is preferably notified by an email that a relevant job has been listed. To initiate the emails, the web server 28 sends a message to the appropriate email server 110, which in turn sends an email to the agency computer 16. In other embodiments, the agency can be alerted by other methods including but not limited to wireless email, pager, phone or fax.

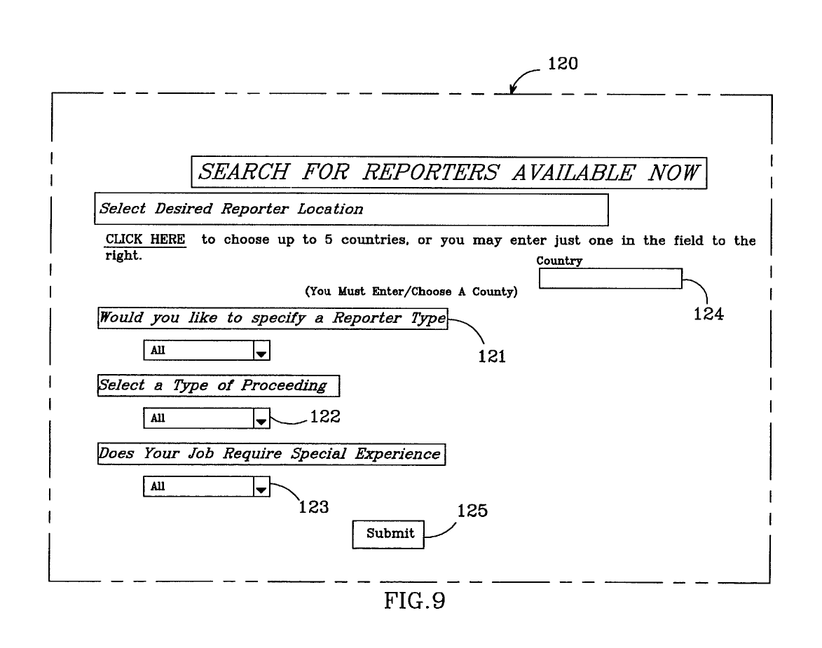

After the agency is enrolled, it can access the subscriber pages and features. It can access the server/site 18 to search for available (activated) professionals by accessing an HTML professional search form, a typical search form 120 shown in FIG. 9. The agency then enters criteria for the specific job including type of reporter 121, type of proceedings 122, special expertise required 123, and geographic area 124. The form is then sent to the site 24 by activating the submit button 125 at the bottom of the form 120. The web server 28 initiates query software 68 within the custom application 34, which conducts a search of the activated professionals in the profile database 40 based on the designated parameters. The web server 28 then produces an electronic report of qualified professionals that is communicated to the agency computer 16 and viewed on the display 18. If the agency wants more detail regarding a particular professional, the agency can view the entire profile for any of the listed professionals. The agency can similarly search the job listing database 38 for current jobs that it could fill.

The agency can also query the profile database 40 to search for subscribing professionals within the same and other professions. The agency can use the search results from the same profession to increase its list of professionals to fill jobs. It can use the search results from other professions to cross-market. The agency can also search other agencies to cross-market to agencies in related professions, such as interpreters or videographers. The agency can also access and update its own profile, update its subscribing information, or cancel its account.

Non-Subscribing Public

Any non-subscribing member of the public can also enter the server/site 18 by using a computer 14 with a standard Web browser 17, but he/she cannot access the subscriber pages and features. The non-subscribing public has limited access to the site 18 and is only permitted to post jobs, contact the site operators, learn more about the system and its operators, learn important employment facts, or access a list of partners in business.

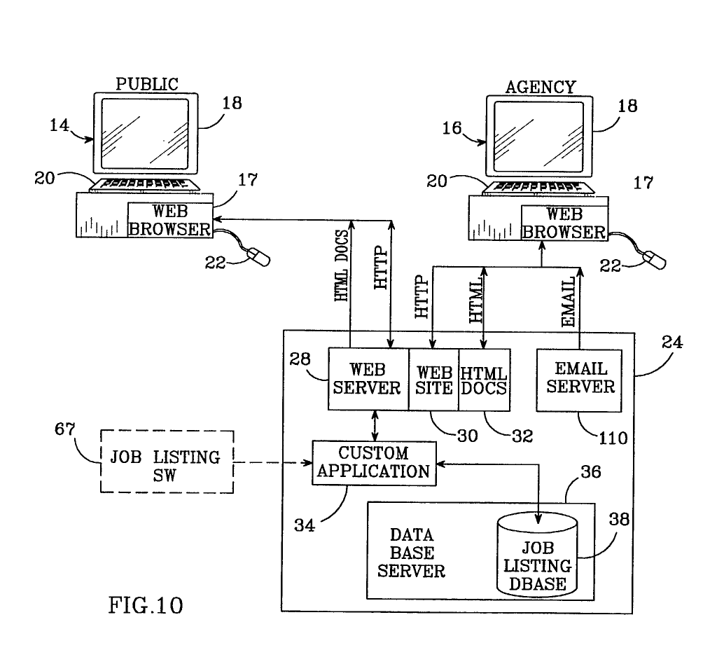

FIG. 10 shows the general flow of information between components when a non-subscribing member of the public accesses the site 24. The public computer 14 uses its Web browser 17 to communicate with the Web server 28 using HTTP protocol. The Web server 28 can then access a store of HTML documents 32 that can be requested, retrieved and viewed at the computer display 18.

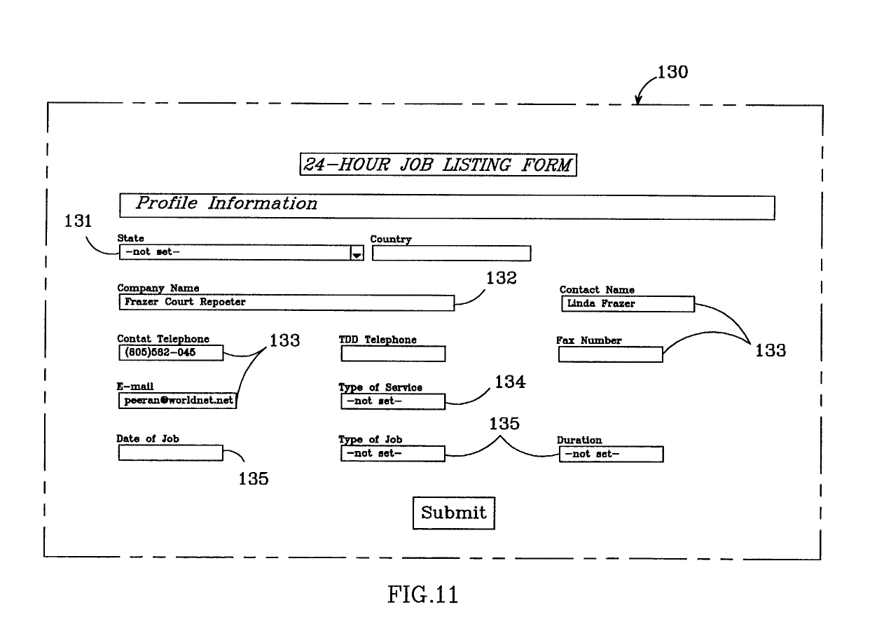

The non-subscribing employer can list a job by selecting the proper option from the Web site's home page. The Web server 28 accesses the job listing form from its store of HTML documents 24 and returns an online job listing registration form 130 as shown in FIG. 11. The form 130 has blanks for information to be provided by nonsubscribing employer to fill in such as job location 131, company name 132, contact information 133, type of service 134 and date/time/duration of job 135. The job information is returned to the server by activating the submit button; and under control of the job listing software 67 in the custom application 34, the job is entered in the job listing database 38. In other embodiments, the public could list jobs by other methods including but not limited to email or phone.

Once a job is listed, the new system 10 alerts appropriate subscribing agencies that the job is available. In the preferred system, the web server 28 communicates with an email server 110 regarding which agencies to email based on the criteria from the job listing from 130, such as type of profession or geographic area. An email message is sent from the email server 110 to the agency computer 16 and each can then fill the job with available professionals or search the profile database 40 to locate available professionals. An agency can also search the database of job listings at any time to determine if there are any jobs it can fill.

The job posting function is primarily used by the non-subscribing public to post last minute jobs, and the job listing remains in the job listing database 38 for a limited amount of time, such as 24 hours. In other embodiments and email message could also be sent to qualified professionals that are activated. If more than one type of service is needed, (e.g. interpreter and court reporter) two different job listings must be submitted.

The non-subscribing public can also view the system contact information forms, which in the preferred embodiment will also include a Hyperlink to email system so that an email can be sent to the Web site operators. Forms providing information and facts can also be accessed and viewed, with many of the forms also having Hyperlinks to related Web sites. Hyperlinks are known in the Internet field as a navigational link from one document to another or from one portion of a document to another. Typically, a Hyperlink is displayed as a highlighted work or phrase that can be selected by clicking on it using a mouse to jump to the associated document.

The non-subscribing public can also view the contents of the partners in business database 30, which lists other businesses related to the various per diem professions. The partners database entries can also include Hyperlinks to the Web sites of the listed partners in business.

In another embodiment of the system 10, the agency can post jobs and a search of the profile database can be conducted to determine which employees (active or inactive) could fill the job. The search could be conducted based on parameters such as geographic location, qualifications, and/or years of experience. An email could then be sent to each of the qualified employees to alert them of the open job.

Although the present invention has been described in considerable detail with reference to certain preferred configurations thereof, other versions are possible. The invention can be used in many situations and can be used with many different types of employees and employers. It can function using different components communicating in different ways. Therefore, the spirit and scope of the appended claims should not be limited to the preferred versions described in the specification.

We claim:

1. A method of matching per diem employees with job openings from employers, comprising:
providing a web site system that includes a browsable employee database, said database comprising a plurality of employee data entries, each of said employee data entries pertaining to a respective one of said employees and each of said data entries having an indicator which indicates whether said respective one of said employees is available for employment;
providing an employee data entry activation system which allows each of said employees to change said indicator in each of said employees respective data entry, said change capable of occurring in real time without interrupting the operation of said Web site;
providing an employee database search system which allows each of said employers to search said database based on selected search parameters, said search system only considering said data entries wherein said indicator indicates that said respective one of said employees is available for employment;
determining which data entries match said search parameters; and
reporting said matching data entries to said one of said employers.

2. The method of claim 1, wherein each of said employee data entries further comprises profile information pertaining to a respective one of said employees, said determination of which data entries match said search parameters made by comparing said search parameters to said profile information in each of said data entries.

3. The method of claim 2, further comprising providing an electronic process to at least partially automate entry of each of said employees profile information into said database by said employees.

4. The method of claim 2, further comprising providing an electronic process to at least partially automate each of said employers access to said database for searching.

5. The method of claim 1, wherein said employee data entry activation system comprises an electronic system which allows each of said employees to remotely change each of said employees respective indicator.

6. The method of claim 1, wherein said employee data entry activation system comprises a telephone interface server which allows each of said employees to remotely change each of said employee's respective indicator by land or cell phone.

7. The method of claim 6, wherein said step of each of said employees changing said indicator in each of said employees respective data entry, further comprises:
said employee dialing said telephone interface system;
said telephone interface system prompting said employee for a password;
said employee entering a password using said phone's keypad;
said password accepted by said telephone interface system and sent to said browsable database;
said browsable database returning said indicator to said telephone interface server;
said telephone interface server notifying said employee of the indicator status and inquiring if said employee would like to change said indicator.

8. The method of claim 1, wherein said method comprises the step of each of said employees subscribing to said web site system before entering said profile information.

9. The method of claim 1, comprising the step of each of said employers subscribing to said web system before searching said database based on selected search parameters.

10. A method of matching per diem employees with job openings from employers, comprising:
providing a Web site system that includes a browsable employee database, said database comprising a plurality of employee database entries, each said entry comprising employee profile information and an indicator which indicates whether said employee is available for employment;
providing a Web site employee subscription system which allows said employee to electronically enter said employee's profile information and availability indicator in said database;
providing an employee profile activation system which allows said employee to change said employee's availability indicator in real time to reflect said employees current availability for employment;
providing a database search system to search said employee database, said search system only searching on said data entries wherein said indicators show that said employee is available for employment;
providing a Web site employer subscription system which allows said employer to utilize said search system to search said database on employer search parameters;
searching said database on said employer search parameters;
determining which said entries in said employee data entry profiles match said parameters; and
electronically reporting said matches to said employer.

11. The method of claim 9, further comprising:
providing a non-subscribing access system, which allows non-subscribing employers to post job listings; and
notification said employers of said job listing.

12. The method of claim 11, wherein said employer notification comprises sending email messages to said employers.

13. The method of claim 10, wherein said employee subscription system at least partially automates entry of employee profiles into said database by said employees.

14. The method of claim 10, wherein said employer subscription system at least partially automates allowing said employer access to said database for searching.

15. The method of claim 10, wherein said employee profile activation system comprises an electronic system which allows said employee to remotely change said employee's respective indicator.

16. The method of claim 10, wherein said employee profile activation system comprises a telephone interface server which allows said employee to remotely change said employee's respective indicator by land or cell phone.

17. The method of claim 16, wherein said step of said employee changing said availability indicator in further comprises:
said employee dialing said telephone interface system;
said telephone interface system prompting said employee for a password;
said employee entering a password using said phone's keypad;
said password accepted by said telephone interface system and sent to said browsable database;
said browsable database returning said indicator to said telephone interface server;
said telephone interface server notifying said employee of the indicator status and inquiring if said employee would like to change said indicator.

18. A computer-implemented system which electronically matches available per diem employees to employers with potential job opportunities that match the employees location and qualifications, comprising:
an electronically browsable employee database which comprises a plurality of employee data entries, each of said plurality of data entries including an employee profile and available indicator pertaining to one of said employees;
an available indicator modification system, which allows each of said employees to electronically change said available indicator in real time;
a search system which allows each of said employers to search said database on selected search parameters, each said profile available for searching when its available indicator is active, said search system only searching said employee profiles with active said available indicators; and
a search result reporting system to electronically report the employee profiles that meet said search parameters.

19. The system of claim 18, further comprising an employee enrollment system which at least partially automates entry of each of said employee profiles into said database by said employees.

20. The system of claim 18, further comprising an employer subscription system which implements an electronic employer subscription process to at least partially automate each of said employers access to said database.

21. The system of claim 18, wherein said search system said determines which data entries match said search parameters made by comparing said search parameters to said employee profile information.

22. The system of claim 18, wherein said availability indicator modification system comprises an electronic system which allows each of said employees to remotely change said employees' respective availability indicator.

23. The system of claim 18, wherein said availability indicator modification system comprises a telephone interface server which allows each of said employees to remotely change said employees' respective indicator by land or cell phone.

24. The method of claim 23, wherein said telephone interface server allows each of said employees to remotely change said employees' respective indicator by one of said employees dialing said telephone interface system, said telephone interface system prompting said one of said employees for a password, said one of said employees entering a password using the keypad one said phone, said password accepted by said telephone interface system and sent to said browsable database, said browsable database returning said indicator to said telephone interface server, said telephone interface server notifying said one of said employees of the indicator status and inquiring if said on of said employees would like to change said indicator.

25. The system of claim 24, wherein said indicator is status is changed by said one of said employees pressing one of the key and said keypad.
